(19) United States
(12) Patent Application Publication
(10) Pub. No.: US 2019/0309761 A1
(43) Pub. Date: Oct. 10, 2019

(54) CEILING FAN EASY FOR MAINTENANCE

(71) Applicant: AIR COOL INDUSTRIAL CO., LTD., Taichung (TW)

(72) Inventor: Tsung-Hsiung WANG, Taichung (TW)

(21) Appl. No.: 16/008,484

(22) Filed: Jun. 14, 2018

(30) Foreign Application Priority Data
Apr. 4, 2018 (CN) 201820474978.5

(51) Int. Cl. F04D 25/08

(52) U.S. Cl. CPC F04D 25/088; F21V 33/0096

(57) ABSTRACT

A ceiling fan easy for maintenance includes a motor housing, which is formed with an accommodating space having a motor provided therein. The motor is connected with a blade unit, and a switch box is provided beneath the blade unit and received therein with a driver, which is electrically connected with the motor. By so designing, in case the driver causes trouble and damage and need to be repaired, a maintenance man only need to open the switch box beneath the motor housing and the blade unit to carry out maintenance and dose not need to disassemble the motor housing. Thus, when doing maintenance work at altitude, the maintenance man can keep away from the blade unit of the ceiling fan, thus able to carry out maintenance of the ceiling fan with great safety and convenience.

### BACKGROUND OF THE INVENTION

### 1. Field of the Invention

This invention relates to a ceiling fan, particularly to one easy for maintenance.

### 2. Description of the Prior Art

A first conventional ceiling fan is to have AC motor making use of AC frequency to control rotating speed. The first conventional ceiling fan has the following shortcomings: 1. Since the AC motor is to increase torsional force with electric current; therefore, the AC motor is apt to generate high temperature. 2. The efficiency of converting electric energy into mechanical energy is low, energy loss being about 70%. 3. The AC motor will cause great vibration and produce loud noise, and the clearance of mechanical members of the motor will be enlarged due to long-term vibration and further, the ceiling fan will cause violent shaking and is easy to damage parts and produce metal shavings, thus difficult in maintenance and resulting in high risk.

A second conventional ceiling fan is to replace the AC motor with a DC brush motor, which is smaller than the AC motor in volume, low in noise and has high efficiency of converting electric energy into mechanical energy and is able to save energy. However, operation and friction of the brush and the armature of the DC brush motor of the second conventional ceiling fan will produce dirt (metal shavings) and sparks; therefore, the second conventional ceiling fan is not suitable for use in a high temperature environment, and the dirt produced by friction of the brush has to be cleaned up periodically and further, the brush and the armature are likely to cause wear due to long-term use to shorten their service life.

A third conventional ceiling fan is to replace the DC brush motor with a DC brushless motor. The DC brushless motor is to generate magnetic filed by coil to actuate the armature to operate so the DC brushless motor without friction of the brush is power saving and quiet. The third conventional ceiling fan 200, as shown in FIG. 1, is formed a motor outer cover 210 received therein with a motor 211 and a driver 212. The motor 211 is pivotally connected with a blade unit 220, and the ceiling fan 200 is firmly fixed at a ceiling by means of a fixing rod 230, a fixing seat 240 and an outer casing 250. A wireless controller 231 is installed in the outer casing 250 and electrically connected with the driver 212, and a remote controller 232 can be employed to transmit wireless signals to the wireless controller 231. Thus, the driver 212 can be controlled by the wireless controller 231 to drive the motor 211 to operate and actuate the blade unit 220 to rotate pivotally. Referring to FIG. 2, for controlling rotating speed of the motor 211, it is necessary to detect the position of the rotor magnetic polarity; therefore, at least one Hall sensor 260, which is provided on a circuit board 265, will be installed near the motor 211, thus enlarging the volume of the motor 211. Since the motor 211 of the ceiling fan 200 is characterized by high current and high horsepower; therefore, the driver 212 used for Hall sensor motor 211 must be able to bear high current, and hence the electronic components of the driver 212 will be comparatively large in volume, thus also enlarging the volumes of both the driver 212 and the motor outer cover 210. Although the third conventional ceiling fan can be operated well, yet, if the motor 211 and the driver 212 need to carry out maintenance, a maintenance man has to stand and work on a service ladder and his standing height is close to the ceiling, and only after both the blade unit 220 and the motor outer cover 210 are disassembled, can the motor 211 and the driver 212 be maintained. Therefore, the third conventional ceiling fan 200 has the following drawbacks: 1. The motor outer cover 210 is bulky; 2. Maintenance is of high risk; 3. It is difficult in maintenance of the driver 212; and 4. Maintenance work can hardly be done by a single person.

In addition, foresaid driver 212 is to have a bunch of signal lines 213 inserted through the fixing rod 230 and electrically connected the wireless controller 231. For this purpose, the conventional signal lines 213 must have a part of the plastic skin removed to expose the external copper wires, as shown in FIG. 3, and then have the metal sheets of a clamp connector 270 respectively clamping tight the copper wires and the plastic skin of the signal lines 213 and lastly, have the signal lines 213 together with the clamp connector 270 inserted into a wiring connector 280 and thus, the driver 212 and the signal lines 213 can be electrically connected with the wireless controller 231 via the wiring connector 280. However, when the ceiling fan is to be repaired and installed, since the fixing rods 230 of various ceiling fans are different in length; therefore, only after the maintenance man prunes the fixing rod 230 and compares the signal lines 213 and reassemble the signal lines 213, the clamp connector 270 and the wiring connector 280, can the wireless controller 231 and the signal lines 213 be connected together, resulting in great inconvenience.

### SUMMARY OF THE INVENTION

The objective of this invention is to offer a ceiling fan easy for maintenance, able to reduce a whole volume of a motor, facilitate assembly, and enhance safety and convenience in maintenance.

The ceiling fan easy for maintenance in the present invention includes a main body containing a motor housing, which is formed with an accommodating space received therein with a motor connected with a blade unit. A switch box is fixed with the main body, positioned beneath the blade unit and composed of at least two covers able to be opened and closed. A driver is installed in the switch box and electrically connected with the motor.

The ceiling fan easy for maintenance of this invention is to have the driver installed in the switch box, able to reduce the volume of the motor housing and, in case the driver causes trouble and damage, a maintenance man only needs to open the switch box beneath the motor housing and the blade unit for maintenance, need not disassemble the motor housing, thus safe and convenient in maintenance of the ceiling fan.

### BRIEF DESCRIPTION OF DRAWINGS

This invention will be better understood by referring to the accompanying drawings, wherein:

FIG. 1 is an exploded perspective view of a conventional ceiling fan;

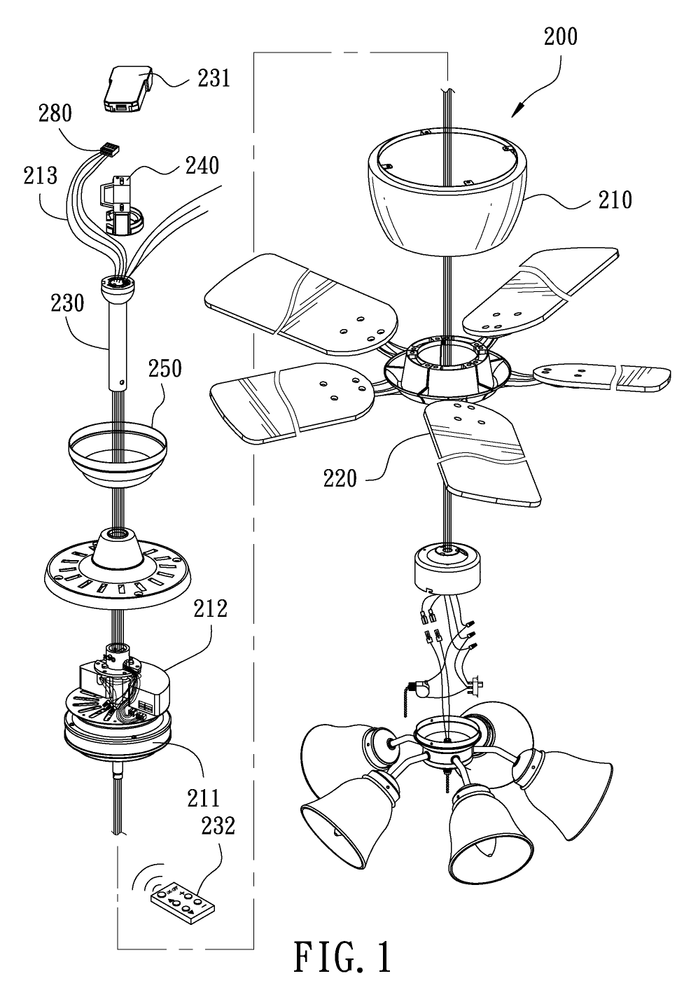

FIG. 2 is a cross-sectional view of a conventional motor outer cover installed therein with a Hall sensor DC brushless motor;

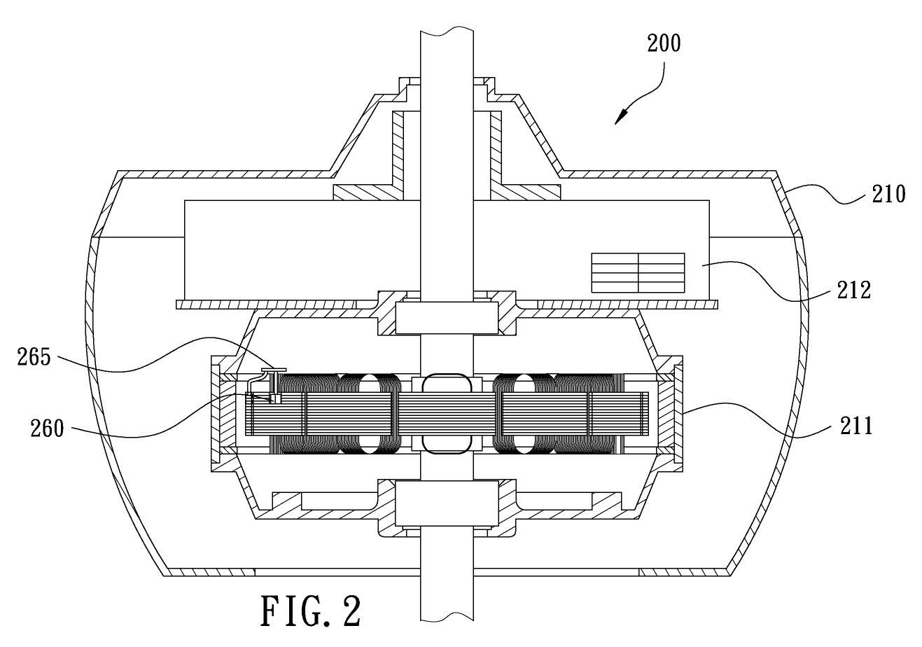

FIG. 3 is a schematic view of connection of the conventional signal lines;

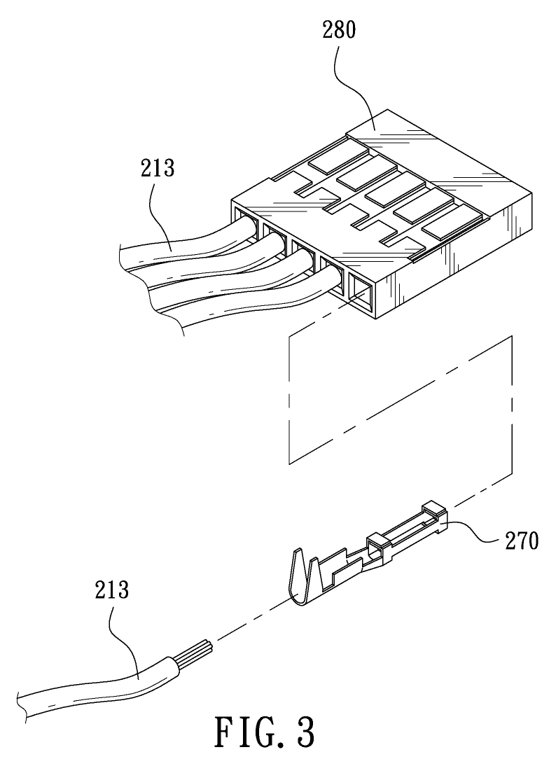

FIG. 4 is a perspective view of a ceiling fan easy for maintenance in the present invention;

FIG. 5 is a schematic view of the ceiling fan easy for maintenance in use in the present invention;

FIG. 6 is an exploded perspective view of the ceiling fan easy for maintenance in the present invention; and

FIG. 7 is a cross-sectional view of the motor housing of the ceiling fan easy for maintenance in the present invention.

### DETAILED DESCRIPTION OF THE PREFERRED EMBODIMENT

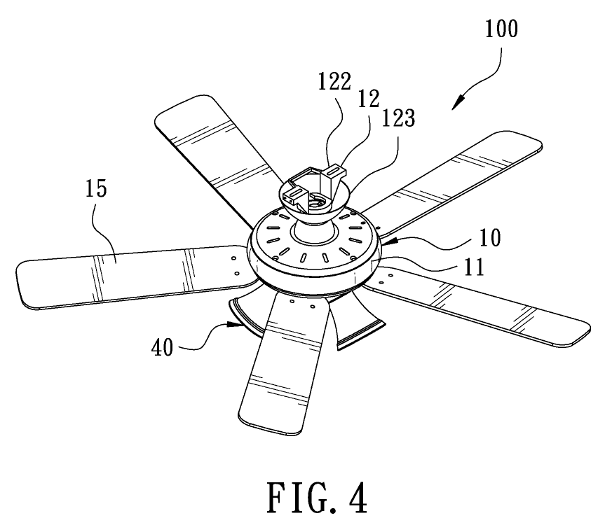

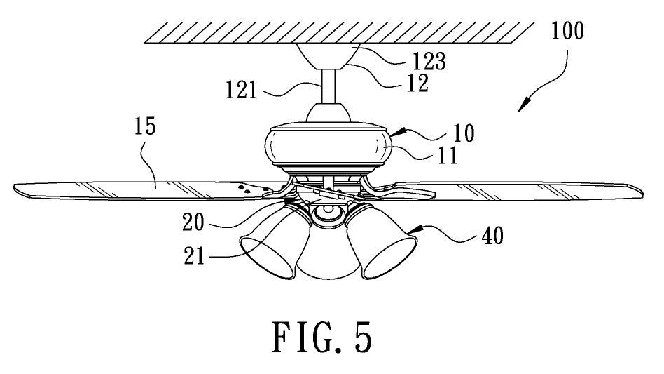

A preferred embodiment of a ceiling fan 100 easy for maintenance in the present invention, as shown in FIGS. 4 and 5 includes a main body 10, a switch box 20, a wireless receiving controller 30, a lamp unit 40, a driver and two manual switches 60 as main components combined together.

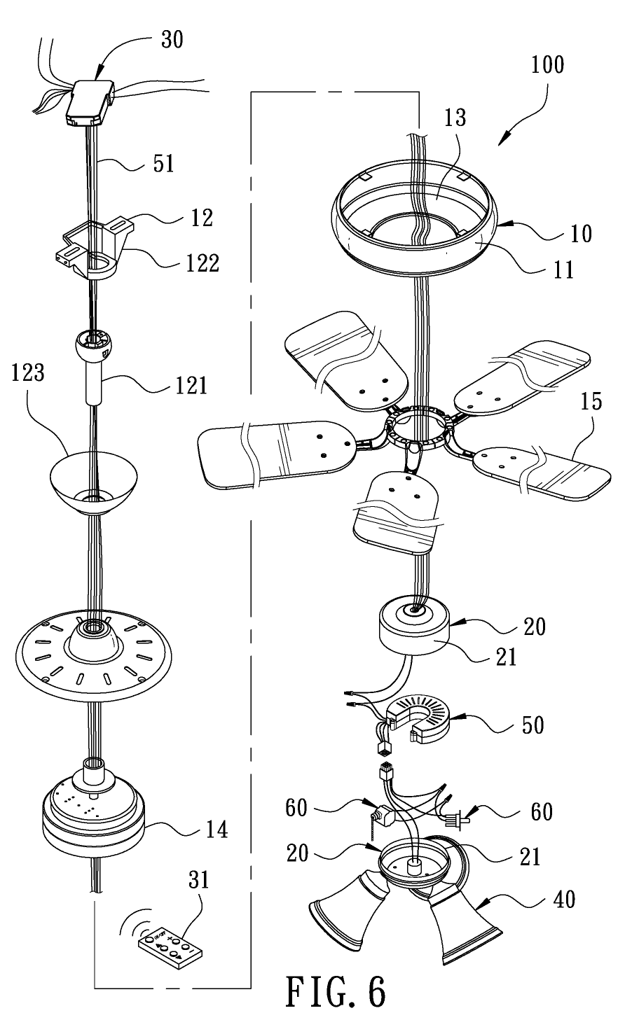

The main body 10, referring to FIG. 6, contains a motor housing 11 and a fixing unit 12. The motor housing 11 is formed with an accommodating space 13 received therein with a motor 14, which is a DC brushless motor without sensor, that is, the motor 14 is a DC brushless motor without Hall element. The motor 14 is connected with a blade unit 15, and the fixing unit 12 consists of a suspension rod 121, a fixing seat 122 and a casing 123. The main body 10 of the ceiling fan 100 is firmly fixed at a ceiling by means of the fixing unit 12.

The switch box 20 is fixedly combined with the main body 10, positioned beneath the blade unit 15 and the motor 14 and composed of two covers 21 able to be opened and closed.

The wireless receiving controller 30 received in the casing 123 can be operated and controlled by a remote controller 31 in a way of transmission of wireless signals.

The lamp unit 40 is combined with the switch box 20.

The driver 50 is provided in the switch box 20 and positioned under the blade unit 15 and the motor 14 and electrically connected with the motor 14, the lamp unit 40 and the wireless receiving controller 30. The driver 50 and the lamp unit 40 are electrically connected with the wireless receiving controller 30 through at least one power line.

The two manual switches 60 are respectively connected with the driver 50 and the lamp unit 40.

In use, after the main body 10 of the ceiling fan 100 is firmly fixed at the ceiling by means of the fixing unit 12, a user can employ the remote controller 31 to operate and control the wireless receiving controller 30 in a way of transmission of wireless signals and simultaneously, the wireless receiving controller 30 will transmit signals to drive the motor 14 to operate via the power line 51. In case the driver 50 causes trouble or damage, maintenance work can be done by a single person. The maintenance man only needs to open the switch box 20 beneath the motor housing 11 and the blade unit 15 for maintenance, needless to disassemble the motor housing 11 and further, when standing at altitude to do maintenance work, the maintenance man can keep away from the blade unit 15, thus safe and convenient in maintenance of the ceiling fan 100.

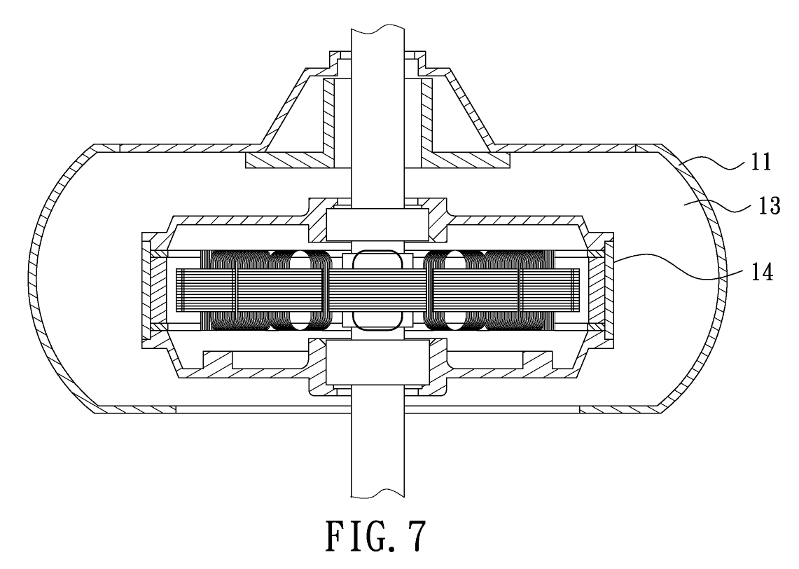

One thing worth mentioning is that the motor 14 is a DC brushless motor without Hall element, and the driver is installed in the switch box 20, as shown in FIGS. 6 and 7; therefore, the motor 14 does not need to install a Hall sensor and a circuit board as the conventional DC brushless motor does, and need not install a brush, either and further, the driver 50 is needless to be mounted in the motor housing 11, thus able to reduce the whole volume and weight of both the motor housing 11 and the motor 14. Furthermore, the volume of the motor 14 of this invention is much smaller than that of both the conventional AC motor and the conventional DC brush motor, able to reduce volume up to 50%, thus facilitating assembly of the ceiling fan 100 and lowering production cost.

Another thing worthy of mentioning is that the ceiling fan easy for maintenance of this invention is able to be electrically connected with the wireless receiving controller 30 and the lamp unit 40 by at least one power line 51; therefore, it is unnecessary to have each signal line pruned for matching the length of the suspension rod 121 and then inserted in the clamp connector and the wiring connector to be fixedly engaged therein as the conventional ceiling fan does. Thus, the maintenance man can conveniently adjust the length of wires, able to reduce time of working at altitude and enhance convenience and safety of maintenance.

In addition, the motor 14 of the ceiling fan 100 of this invention is a DC brushless motor without Hall element, and compared with the conventional AC motor and the conventional DC brush motor as well as the conventional DC brushless motor, the motor 14 of this invention has higher conversion efficiency in converting electric energy into mechanical energy, and the maximum increase rate of conversion is about 80%. Further, the motor 14 of this invention is provided with no brush, energy and power saving, small in volume, light in weight, fixed in torque and stable in temperature change rate and hence applicable to a high temperature environment. Furthermore, unlike the conventional motor, the motor 14 of this invention can avoid producing sparks, metal shavings and vibration noise, which are caused by friction of the brush, able to lower vibration of the ceiling fan 100 and enhance reliability and stability of the ceiling fan used at a high location.

While the preferred embodiment of this invention has been described above, it will be recognized and understood that various modifications may be made therein and the appended claims are intended to cover all such modifications that may fall within the spirit and scope of the invention.

What is claimed is:

1. A ceiling fan easy for maintenance comprising:
a main body provided with a motor housing, said motor housing formed with an accommodating space, said accommodating space received therein with a motor, said motor connected with a blade unit;
a switch box secured with said main body, said switch box positioned beneath said blade unit, said switch box composed of at least two covers able to be opened and closed; and
a driver received in said switch box, said driver electrically connected with said motor.

2. The ceiling fan easy for maintenance as claimed in claim 1, wherein said main body comprises a fixing unit, said fixing unit provided with a suspension rod, a fixing seat and a casing, said main body firmly fixed at a ceiling by means of said fixing unit.

3. The ceiling fan easy for maintenance as claimed in claim 2, wherein said main body further comprises a wireless receiving controller, said wireless receiving controller installed in said casing, said driver electrically connected with said wireless receiving controller, said wireless receiving controller operated and controlled by a remote controller in a way of transmission of wireless signals.

4. The ceiling fan easy for maintenance as claimed in claim 3, wherein said ceiling fan comprises a lamp unit, said lamp unit combined with said switch box, said driver electrically connected with said wireless receiving controller and said lamp unit.

5. The ceiling fan easy for maintenance as claimed in claim 4, wherein said wireless receiving controller is electrically connected with both said driver and said lamp unit by means of at least one power line.

6. The ceiling fan easy for maintenance as claimed in claim 4, wherein said ceiling fan further comprises two manual switches, said two manual switches respectively connected with said driver and said lamp unit.

7. The ceiling fan easy for maintenance as claimed in claim 1, wherein said motor is a DC brushless motor without sensor.

8. The ceiling fan easy for maintenance as claimed in claim 7, wherein said motor is a DC brushless motor without Hall element.
